(19) United States
(12) Patent Application Publication
(10) Pub. No.: US 2025/0224298 A1
(43) Pub. Date: Jul. 10, 2025

(54) Method and Apparatus for Identifying a Malfunction of Contactors of a DC Voltage Charging Connection for an Electric Vehicle

(71) Applicant: Vitesco Technologies GmbH, Regensburg (DE)

(72) Inventors: Christian Weber, Sinzing (DE); Gerhard Eser, Hemau (DE)

(73) Assignee: Vitesco Technologies GmbH, Regensburg (DE)

(21) Appl. No.: 18/852,845

(22) PCT Filed: Mar. 30, 2023
(86) PCT No.: PCT/EP2023/058277

§ 371 Date: Sep. 30, 2024

(30) Foreign Application Priority Data
Mar. 31, 2022 (DE) 10 2022 203 196.2

(51) Int. Cl. G01L 27/00; B60L 3/00; H01M 10/48

(52) U.S. Cl. CPC G01L 27/007; B60L 3/0046; H01M 10/48; B60L 2240/54; H01M 2220/20

(57) ABSTRACT

Various embodiments of the teachings herein include methods for determining the functional operability of a pressure sensor of a battery arrangement with a battery housing in a vehicle, wherein the pressure sensor generates a pressure signal corresponding to the pressure within the battery housing. An example includes: introducing a gas mixture into the battery housing from outside the battery housing for the purpose of increasing the pressure within the battery housing; and determining that the pressure sensor is functional if, after the process of introducing the gas mixture into the battery housing, the pressure signal of the pressure sensor indicates a pressure which exceeds a predetermined pressure threshold value; else determining that the pressure sensor is malfunctioning.

### CROSS-REFERENCE TO RELATED APPLICATIONS

This application is a U.S. National Stage Application of International Application No. PCT/EP2023/058277 filed Mar. 30, 2023, which designates the United States of America, and claims priority to DE Application No. 10 2022 203 196.2 filed Mar. 31, 2022, the contents of which are hereby incorporated by reference in their entirety.

### TECHNICAL FIELD

The present disclosure relates to battery systems. Various embodiments of the teachings herein include systems and/or methods for determining the functional operability of a pressure sensor of a battery arrangement for a vehicle.

### BACKGROUND

Lithium-ion batteries are currently used in electromobility, both for hybrid vehicles and for all-electric vehicles. In the case of lithium-ion batteries, aluminum electrodes on the cathode side and copper electrodes on the anode side are used as current collectors, each usually in film form. Lithium transition metal oxides, such as cobalt, manganese and nickel, for example, find application as cathode material and carbon/graphite find application as anode material. The electrolyte situated therebetween consists of organic solvent with dissolved electrolyte salts. In order to avoid short circuits, a lithium ion-permeable separator (e.g. composed of polypropylene) may be positioned between the electrodes.

For long-lasting operation, the battery cells are neither overcharged nor discharged too much, since faster aging with deactivation of active constituents of the electrodes and an increase in the cell impedance and also thermal “runaway” of the respective cell, i.e. total failure, may thus occur. For this purpose, it is of crucial importance to know the present state of charge.

During the operation of lithium-ion batteries, it is important to operate the battery in the correct temperature range. Battery overheating, in particular, is deemed to be particularly hazardous since unstoppable thermal runaway may occur starting from a critical temperature. In that case, the individual components of the battery cell react with one another in an uncontrolled manner. With very great evolution of heat and gas formation, the cell reacts until all the components have fully reacted. During thermal runaway, gas formation occurs in the respective battery cell and the internal pressure increases until the housing of the battery cell yields and the latter ruptures. The gas generated thus escapes. The battery cell is heated up further until the uncontrollable reaction starts and the battery cell abruptly reacts completely.

The gases generated and liberated in the process may comprise hydrogen, carbon dioxide, carbon monoxide and hydrocarbons, such as methane or ethane, for example. Depending on the progress of the reaction and thus of thermal runaway, characteristic gas concentrations can be measurable, whereby the state of the battery can be deduced.

Future monitoring systems will therefore use one or more different gas sensors which are energized continuously or in significant intervals and can thus detect the gas concentrations within the battery housing. The gas sensor can thus permanently or cyclically detect the composition of the gas present within the battery housing and output a signal on the basis of which the state of the battery can be assessed.

Since the battery housing or the parts forming the battery housing according to the prior art are of air-permeable design, the pressure within the battery housing may vary depending on ambient pressure. As a result of a pressure fluctuations in the surroundings (e.g. change of weather, operation of the vehicle at a varying altitude, etc.), the pressure within the battery housing changes as well. Consequently, the state of the battery cannot be exactly deduced solely by measurement of the gas concentration within the battery housing, rather it might be necessary also to measure the pressure within the battery housing or an internal pressure derived by measurement and/or modeling of the ambient pressure could be used to correct the ascertained value of the gas concentration measurement.

In phases of inactivity of the vehicle and thus also of the battery arrangement, e.g. when parking without charging, the battery arrangement is not monitored. If a fault of the battery arrangement occurs, such as, for example, a short circuit, mechanical damage, etc., impermissible heating of one or more battery cells may occur. Thermal runaway of the battery cells may occur in the worst case.

There are already known methods which attempt to overcome this aforementioned problem for cyclically activating the pressure sensor during an inactive phase of the battery or of the battery management system. The pressure sensor cyclically measures the pressure within the battery housing and assesses whether a critical state is present. As a follow-up measure, the battery management system can be activated and emergency measures can be initiated, such as, for example, disconnecting the connection of the battery by means of the safety contactors.

Exemplary methods and devices are known from U.S. Pat. Nos. 9,207,143 B2, 8,459,099 B2, 5,361,622 A, 5,497,654 A, 9,150,169 B2 and 9,400,262 B2. The methods known from the prior art are passive methods, that is to say that the pressure sensor can be checked for functional operability only in the case of a pressure increase within the battery housing on account of a fault.

### SUMMARY

The teachings of the present disclosure include systems and methods which enable a pressure sensor of a battery arrangement of a vehicle to be checked for functional operability in a simple and expedient manner, e.g., independently of the operating state of the vehicle. For example, some embodiments include a method for determining the functional operability of a pressure sensor (140) of a battery arrangement (100) having a battery housing (110) for a vehicle, wherein the pressure sensor (140) is designed to generate a pressure signal which indicates the pressure within the battery housing (110), wherein the method comprises: introducing a gas mixture into the battery housing (110) from outside the battery housing (110) for the purpose of increasing the pressure within the battery housing (110), and determining that the pressure sensor (140) is functional if, after the process of introducing the gas mixture into the battery housing (110), the pressure signal of the pressure sensor (140) indicates a pressure which exceeds a predetermined pressure threshold value.

In some embodiments, introducing the gas mixture into the battery housing (110) comprises: connecting an external gas source to a connection (150) of the battery housing (110), and feeding the gas mixture via the connection (150) into the battery housing (110) from the external gas source.

In some embodiments, the battery arrangement (100) comprises a gas store (170), which is fluidically connected to the battery housing (110) and in which the gas mixture is stored, and a control valve (190) designed to open or close the fluidic connection between the gas store (170) and the battery housing (110), wherein introducing the gas mixture into the battery housing (110) comprises opening the control valve (190) for the purpose of feeding the gas mixture into the battery housing (110) from the gas store (170).

In some embodiments, the gas mixture comprises air.

In some embodiments, introducing the gas mixture into the battery housing (110) takes place for a predetermined time duration, and the pressure sensor (140) is determined as functional if the pressure signal indicates a pressure which exceeds the predetermined pressure threshold value within the predetermined time duration.

In some embodiments, the battery arrangement (100) furthermore comprises a gas sensor (130) designed to be sensitive to at least one gas component present within the battery housing (110) and to generate a gas signal indicating the content of the gas component within the battery housing (110), wherein the method furthermore comprises determining that the gas sensor (130) is functional if, after the process of introducing the gas mixture into the battery housing (110), the gas signal of the gas sensor (130) indicates a content of the gas component which exceeds a predetermined content threshold value.

As another example, some embodiments include a battery arrangement (100) for a vehicle, comprising: a battery housing (110) with at least one battery cell (120) arranged therein, a pressure sensor (140) designed to generate a pressure signal which indicates the pressure within the battery housing (110), and a control unit (160) designed to carry out one or more of the methods for determining the functional operability of the pressure sensor (140) as described herein.

In some embodiments, the battery housing (110) comprises a connection (150) to which an external gas source is connectable for the purpose of introducing the gas mixture into the battery housing (110).

In some embodiments, the battery arrangement (100) furthermore includes: a gas store (170), which is fluidically connected to the battery housing (110) and in which the gas mixture is stored, and a control valve (190) designed to open or close the fluidic connection between the gas store (170) and the battery housing (110).

In some embodiments, the battery arrangement (100) furthermore includes a gas sensor (130) designed to be sensitive to at least one gas component present within the battery housing (110) and to generate a gas signal indicating the content of the gas component within the battery housing (110).

### BRIEF DESCRIPTION OF THE DRAWINGS

Further advantages and features of the teachings of the present disclosure are apparent to a person skilled in the art by putting the teaching described herein into practice and taking into consideration the accompanying single drawing, in which:

FIG. 1 shows a schematic illustration of an example battery arrangement for a vehicle incorporating teachings of the present disclosure;

FIG. 2 shows a schematic illustration of a further battery arrangement incorporating teachings of the present disclosure; and

FIG. 3 shows a flow diagram for an example method incorporating teachings of the present disclosure for checking the functional operability of a gas sensor of the battery arrangement from FIG. 1.

### DETAILED DESCRIPTION

Various embodiments of the teachings herein include checking a pressure sensor of a battery arrangement for a vehicle with regard to its functional operability by way of introducing a gas mixture into the battery housing from outside and thus artificially altering, e.g. increasing, the pressure within the battery housing. If the pressure sensor detects such an alteration (or increase) of the pressure within the battery housing, the pressure sensor can be diagnosed as functional. However, if the pressure sensor does not indicate a corresponding change or the change in the pressure signal of the pressure sensor does not correspond to a change expected owing to the introduction of the gas mixture into the battery housing, a pressure sensor that is no longer functioning properly can be assumed. At the same time the pressure signal of the pressure sensor can be quantitatively evaluated during the process of introducing the gas mixture into the battery housing in order likewise to diagnose the pressure sensor. Furthermore, it may be possible to diagnose further elements of the battery arrangement on the basis of the pressure signal of the pressure sensor, such as the seal of the battery housing, for example.

Some embodiments of the teachings herein include a method for determining the functional operability of a pressure sensor of a battery arrangement having a battery housing for a vehicle. The pressure sensor is designed to generate a pressure signal which indicates the pressure within the battery housing. The method comprises introducing a gas mixture into the battery housing from outside the battery housing for the purpose of increasing the pressure within the battery housing, and determining that the pressure sensor is functional if, after the process of introducing the gas mixture into the battery housing, the pressure signal of the gas sensor indicates a pressure which exceeds a predetermined pressure threshold value.

In particular, the pressure signal of the pressure sensor can be evaluated at least qualitatively. Specifically, if, after the process of introducing the gas mixture into the battery housing, the pressure signal of the pressure sensor indicates a pressure which exceeds the predetermined pressure threshold value, it can be assumed that the pressure sensor is functioning at least in part and can at least qualitatively detect the pressure change brought about from outside in a targeted manner in the interior of the battery housing. In some embodiments, the pressure signal of the pressure sensor can also be ascertained quantitatively in order to be able to ascertain a specific fault of the pressure sensor, such as a drift of the pressure sensor, for example. Furthermore, it is possible to investigate whether the pressure signal of the pressure sensor changes at all after the gas mixture has been introduced.

In some embodiments, the predetermined pressure threshold value is chosen in such a way that it is at least partly greater than the pressure within the battery housing which the pressure sensor indicates before the gas mixture is introduced. In this case, before the gas mixture is introduced, the pressure signal of the pressure sensor is evaluated and the predetermined pressure threshold value is chosen in such a way that it is greater than the presently indicated pressure within the battery housing.

In some embodiments, introducing the gas mixture into the battery housing comprises connecting an external gas source to a connection of the battery housing, and feeding the gas mixture via the connection into the battery housing from the external gas source. For example, during technical inspections that are to be performed cyclically, such as those done by the TÜV known in Germany (TÜV=Technischer Überwachungsverein [Technical Inspection Association]), for example, the gas mixture, preferably air, can be introduced into the battery housing from outside and the pressure sensor can be checked with regard to its functional operability.

In some embodiments, the battery arrangement furthermore comprises a gas store, which is fluidically connected to the battery housing and in which the gas mixture is stored and a control valve designed to open or close the fluidic connection between the gas store and the battery housing. In this case, introducing the gas mixture into the battery housing comprises opening the control valve for the purpose of feeding the gas mixture into the battery housing from the gas store. Such a configuration enables a gas store, such as an air store, for example, to be permanently taken along with the vehicle and thus enables a diagnosis of the pressure sensor to be carried out cyclically even during operation of the vehicle. In some embodiments, the gas mixture at least partly comprises air.

In some embodiments, introducing the gas mixture into the battery housing takes place for a predetermined time duration until a predetermined pressure value has been reached within the battery housing. In this case, it is furthermore preferred if the pressure sensor is determined as functional if the pressure signal indicates a pressure which exceeds the predetermined pressure threshold value within the predetermined time duration. In particular, this configuration of the method describes quantitative evaluation of the pressure signal. If the pressure sensor is contaminated, for example, in the predetermined time the pressure sensor can no longer detect the externally generated pressure changes within the battery housing as usual in the predetermined time duration, but rather more slowly. Such a fault of the pressure sensor can be detected by means of such a configuration.

In some embodiments, the battery arrangement furthermore comprises a gas sensor designed to be sensitive to at least one gas component present within the battery housing and to generate a gas signal indicating the content of the gas component within the battery housing. In this case, such a method furthermore comprises determining that the gas sensor is functional if, after the process of introducing the gas mixture into the battery housing, the gas signal of the gas sensor indicates a content of the gas component which exceeds a predetermined content threshold value.

Introducing the gas mixture which in this case comprises at least one gas component to which the gas sensor is sensitive enables both the pressure sensor and the gas sensor to be checked with regard to their respective functional operability. Specifically, if the gas sensor outputs a gas signal which does not exceed the predetermined content threshold value, the gas sensor can be diagnosed as at least partly defective since it does not detect the introduced gas component to which the gas sensor would be sensitive in the event of functional operability.

In some embodiments, a battery arrangement for a vehicle comprises a battery housing with at least one battery cell arranged therein, a pressure sensor designed to generate a pressure signal which indicates the pressure within the battery housing, and a control unit designed to carry out one or more of the methods described herein for determining the functional operability of the pressure sensor.

In some embodiments, the battery housing furthermore comprises a connection to which an external gas source is connectable for the purpose of introducing the gas mixture into the battery housing. In this case, the connection of the battery housing may be a standardized gas connection which is known from the prior art and which an external gas source can be connected via a corresponding gas line with an appropriate connection.

In some embodiments, the battery arrangement can comprise a gas store, which is fluidically connected to the battery housing and in which the gas mixture is stored, and a control valve designed to open or close the fluidic connection between the gas store and the battery housing. In such a configuration, the battery arrangement furthermore comprises a gas store, from which the gas mixture stored therein can be introduced into the battery housing for the purpose of diagnosing the pressure sensor by way of corresponding control of the control valve.

In some embodiments, there is a gas sensor designed to be sensitive to at least one gas component present within the battery housing and to generate a gas signal indicating the content of the gas component within the battery housing. In such a configuration, the gas mixture introduced into the battery housing from outside furthermore comprises at least one gas component to which the gas sensor is sensitive. Consequently, both the pressure sensor and the gas sensor can be checked with regard to their respective functional operability.

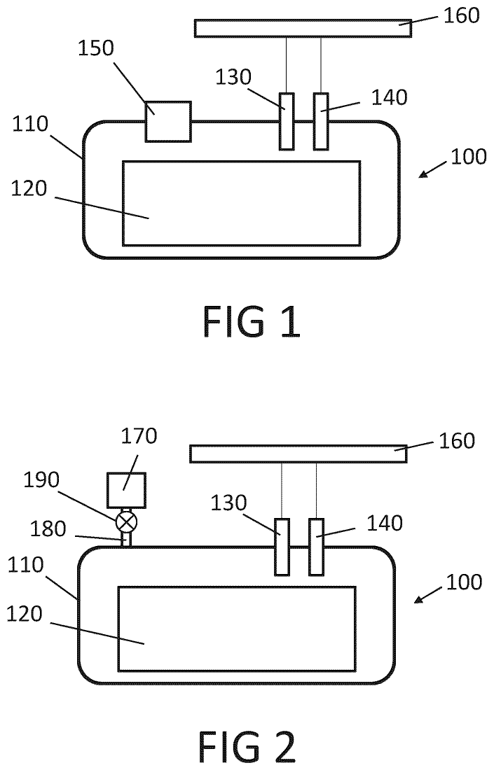

FIG. 1 shows a battery arrangement 100 incorporating teachings of the present disclosure, comprising a battery housing 110 designed to accommodate a battery 120. The battery 120 can comprise at least one battery cell. The battery 120 is schematically illustrated as a block in FIG. 1, where it is self-evident to a person skilled in the art that the battery 120 and also the battery cells can be arranged.

The battery arrangement 100 in FIG. 1 furthermore comprises a gas sensor 130 sensitive to at least one gas component present within the battery housing 110 and to generate a gas signal indicating the content of the gas component within the battery housing 110. In this case, the gas sensor 130 can both qualitatively and quantitatively indicate the content of the gas component within the battery housing. In some embodiments, the gas sensor 130 is sensitive to such gas components which are generated during abnormal chemical reactions within the battery housing 110.

In particular, the gas sensor 130 can recognize such an abnormal chemical reaction, whereupon a corresponding warning can be issued to the driver of the vehicle.

By way of example, during thermal runaway of at least one battery cell 120, hydrogen, carbon dioxide, carbon monoxide and hydrocarbons, such as methane or ethane, for example, may be generated and can be detected by the gas sensor 130. Depending on the progress of the reaction and thus of thermal runaway, the gas sensor 130 can detect the characteristic gas concentrations of the respective gas component, whereby the state of the battery or battery cells 120 can be deduced.

The battery arrangement 100 in FIG. 1 furthermore comprises a pressure sensor 140 designed to generate a pressure signal which indicates the pressure within the battery housing 110. In some embodiments, the battery arrangement 100 can furthermore comprises a temperature sensor (not illustrated in the drawings) designed to detect the temperature within the battery housing 110. In particular, the temperature sensor can detect the gas temperature of the gas, e.g. air, surrounding the battery 120 within the battery housing 110. The “interior of the battery housing 110” comprises that free region which surrounds the battery 120. In particular, it involves the gas-filled region-situated within the battery housing 110-around the battery 120.

The battery arrangement 100 in FIG. 1 furthermore comprises a connection 150 to which an external gas source can be connected in such a way that, from the external gas source (not explicitly illustrated in the drawings), a gas mixture can be introduced into the interior of the battery housing 110 via the connection 150. In this case, the connection 150 may be a standardized mechanical connection having a coupling element which can be releasably connected to an appropriately matching coupling element at the external gas source.

The battery module 100 furthermore comprises a control device 160, which is electrically connected to the gas sensor 130 and the pressure sensor 140 and is designed to carry out one or more of the methods described herein for determining the functional operability of the gas sensor 130.

FIG. 2 shows another example battery arrangement 100 incorporating teachings of the present disclosure similar to the battery arrangement 100 in FIG. 1. In particular, the battery arrangement 100 in FIG. 2 differs from the battery arrangement 100 in FIG. 1 in that, instead of the connection 150, a gas store 170 is provided, which is fluidically connected to the battery housing 110 by means of a connecting line 180 and in which the gas mixture is stored, preferably under pressure. In addition, the battery arrangement 100 in FIG. 2 comprises a control valve 190 designed to open or close the fluidic connection between the gas store 170 and the battery housing 110. In some embodiments, the gas store 170 is a gas cartridge which stores a predetermined quantity of the gas mixture and keeps it available, preferably under pressure, for feeding into the interior of the battery housing 110. The control valve 190 can be an electrically controllable valve, such as a gas solenoid valve, for example, which is in the closed position when deenergized.

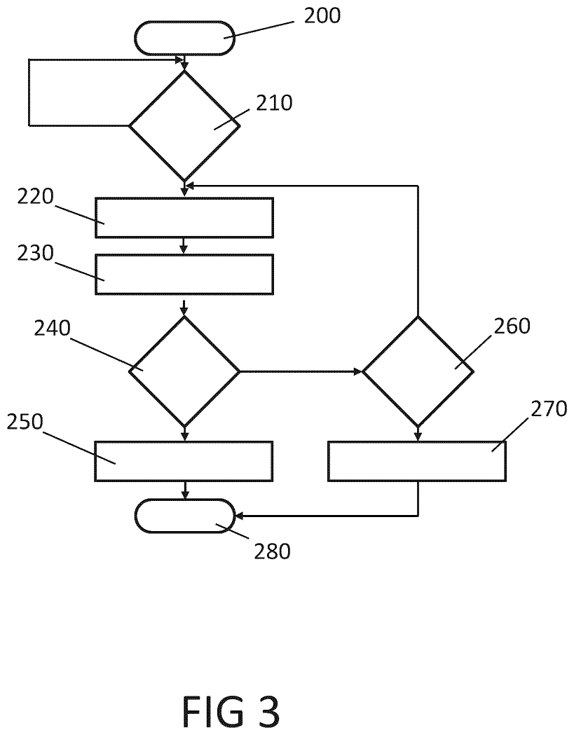

Referring to FIG. 3, an example method for determining the functional operability of the pressure sensor 140 of the battery arrangement 100 from FIG. 1 is described hereinafter. The method in FIG. 3 starts at step 200 and then proceeds to step 210, which involves ascertaining whether a diagnosis of the pressure sensor 140 is necessary at all. A diagnosis of the pressure sensor 140 may be necessary in particular during operating times of the vehicle in which both the battery arrangement and the vehicle are deactivated, for example during parking of the vehicle during which the battery arrangement 100 is not charged. The method in FIG. 3 remains at step 210 until a corresponding necessity for the diagnosis of the functional operability of the pressure sensor 140 has been ascertained.

If step 210 ascertains that a diagnosis of the functional operability of the pressure sensor 140 is necessary, the method proceeds to step 220, in which an external gas source, such as air source, for example, is connected to the connection 150 of the battery arrangement 100 from FIG. 1 and the gas mixture is introduced into the interior of the battery housing 110 via the connection 150.

In a subsequent step 230, the pressure within the battery housing 110 is detected by means of the pressure sensor 140. A subsequent step 240 involves checking whether the pressure signal generated by the pressure sensor 140 indicates a pressure in the interior of the battery housing 110 which exceeds a predetermined pressure threshold value. If step 240 determines that the pressure signal generated by means of the pressure sensor 140 indicates a pressure which exceeds the predetermined pressure threshold value, the method proceeds to step 250, in which the gas sensor 130 is diagnosed as functional, before the method ends at step 280.

By contrast, if step 240 determines that the pressure signal generated by the pressure sensor 130 indicates a pressure which does not exceed the predetermined pressure threshold value, the method proceeds to step 260, which involves checking whether a predetermined time duration has been exceeded. In this case, the predetermined time duration specifies a time duration during which the pressure signal of a functional pressure sensor 140 should indicate a pressure exceeding the predetermined pressure threshold value.

If step 260 determines that the predetermined time duration has not yet been reached, the method returns to step 220. In particular, the method remains in the loop of steps 220, 230, 240 and 260 either until the pressure signal of the pressure sensor 140 indicates a pressure which exceeds the predetermined pressure threshold value, or until the predetermined time duration is reached.

Specifically, if step 260 determines that the predetermined time duration has been exceeded, the method proceeds to step 270, in which the pressure sensor 140 is diagnosed as non-functional, before the method in turn ends at step 280.

If the pressure signal of the pressure sensor 140 does not indicate the altered pressure within the battery housing 110 in the predetermined time duration, it can be established, for example, that the pressure sensor 140 has the “stuck in range” fault. In this case, a “stuck in range” fault denotes a voltage value of the sensor which lies in a voltage value range not relevant to electrical faults, but the sensor responds implausibly to external excitations, such as e.g. the introduction of the test gas, and does not follow the expected voltage value. Such a case may occur for example if a possible access to the sensor element of the pressure sensor 140 for gases, in particular air, is blocked, for example by contamination, or the sensor element of the pressure sensor 140 is contaminated. In such a fault case, the pressure sensor 140 cannot detect a peak pressure even in the case of thermal runaway and, consequently, does not work properly.

The so-called fault cases of “stuck high”, in which the pressure signal of the pressure sensor 140 permanently indicates a peak pressure value, or “slow dynamic”, in which the pressure signal of the pressure sensor 140 changes only very slowly on account of contaminants within the pressure sensor 140, can be identified in a similar manner. Moreover, an inadequate correlation between the pressure signal of the pressure sensor 140 and the generated pressure within the battery housing 110 can also be regarded as a fault case. By way of example, it may be ascertained that the pressure sensor 140 has fallen out of its mount and/or that the battery housing 110 is not tight if the pressure sensor 140 does not react to the pressure change. The reaction of the proper pressure sensor 140 is known and an attempt is made to derive fault cases on account of the deviation upon a standard excitation.

In some embodiments, the method includes additionally checking the functional operability of the gas sensor 130. In this case, in step 220, a gas mixture comprising at least one gas component to which the gas sensor 130 is sensitive can be introduced into the battery housing 110. If the gas sensor 130 detects the gas component introduced in this way, a properly functioning gas sensor 130 can be assumed. However, if it is ascertained that the gas signal of the gas sensor 130 substantially does not change despite the gas component introduced into the battery housing 110, the gas sensor 140 can be diagnosed as not functioning properly.

In accordance with this configuration of the method, introducing the gas mixture which comprises at least one gas component to which the gas sensor 130 is sensitive enables both the gas sensor 130 and the pressure sensor 140 to be checked with regard to their respective functional operability. This creates a simple and cost-effective way of enabling both the gas sensor 130 and the pressure sensor 140 to be reliably checked with regard to their functional operability, in particular at regular intervals.

What is claimed is:

1. A method for determining the functional operability of a pressure sensor of a battery arrangement with a battery housing in a vehicle, wherein the pressure sensor generates a pressure signal corresponding to a the pressure within the battery housing, the method comprising:
introducing a gas mixture into the battery housing from outside the battery housing for the purpose of increasing the pressure within the battery housing; and
determining that the pressure sensor is functional if, after the process of introducing the gas mixture into the battery housing, the pressure signal of the pressure sensor indicates a pressure which exceeds a predetermined pressure threshold value;
else determining that the pressure sensor is malfunctioning.

2. The method as claimed in claim 1, wherein introducing the gas mixture into the battery housing comprises:
connecting an external gas source to a connection of the battery housing; and
feeding the gas mixture via the connection into the battery housing from the external gas source.

3. The method as claimed in claim 1, wherein the battery arrangement comprises:
a gas store fluidically connected to the battery housing and storing the gas mixture; and
a control valve to open or close the fluidic connection between the gas store and the battery housing;
wherein introducing the gas mixture into the battery housing comprises
opening the control valve to feed the gas mixture into the battery housing from the gas store.

4. The method as claimed in any claim 1, wherein the gas mixture comprises air.

5. The method as claimed in claim 1,
wherein:
introducing the gas mixture into the battery housing takes place for a predetermined time duration; and
the pressure sensor is determined functional if the pressure signal indicates a pressure which exceeds the predetermined pressure threshold value within the predetermined time duration.

6. The method as claimed in claim 1, wherein:
the battery arrangement furthermore comprises a gas sensor sensitive to a gas component present within the battery housing and operable to generate a gas signal indicating the content of the gas component within the battery housing;
wherein the method furthermore comprises
determining that the gas sensor is functional if, after the process of introducing the gas mixture into the battery housing, the gas signal of the gas sensor indicates a content of the gas component which exceeds a predetermined content threshold value.

7. A battery arrangement for a vehicle, the arrangement comprising:
a battery housing with a battery cell arranged therein;
a pressure sensor to generate a pressure signal corresponding to a pressure within the battery housing; and
a control unit to determine functional operability of the pressure sensor by:
introducing a gas mixture into the battery housing from outside the battery housing for the purpose of increasing the pressure within the battery housing; and
determining that the pressure sensor is functional if, after the process of introducing the gas mixture into the battery housing, the pressure signal of the pressure sensor indicates a pressure which exceeds a predetermined pressure threshold value;
else determining that the pressure sensor is malfunctioning.

8. The battery arrangement as claimed in claim 7, wherein the battery housing comprises a connection for an external gas source to introduce the gas mixture into the battery housing.

9. The battery arrangement as claimed in claim 7, further comprising:
a gas store fluidically connected to the battery housing and storing the gas mixture; and
a control valve to open or close the fluidic connection between the gas store and the battery housing.

10. The battery arrangement as claimed in 7, further comprising
a gas sensor sensitive to a gas component present within the battery housing and operable to generate a gas signal indicating a content of the gas component within the battery housing.
